(19) United States
(12) Patent Application Publication
(10) Pub. No.: US 2024/0408736 A1
(43) Pub. Date: Dec. 12, 2024

(54) WORKING TOOL, WORKING MEMBER OF THE WORKING TOOL, AND WORKING TOOL KIT

(71) Applicant: TECHTRONIC CORDLESS GP, Anderson, SC (US)

(72) Inventors: Lawrence Fung Pok LO, Hong Kong (CN); Chun Kit Benson CHEUNG, Hong Kong (CN)

(21) Appl. No.: 18/698,678

(22) PCT Filed: Nov. 23, 2021
(86) PCT No.: PCT/CN2021/132385

§ 371 Date: Apr. 4, 2024

(51) Int. Cl. B25F 3/00; B26D 3/00; B26F 3/12

(52) U.S. Cl. CPC B25F 3/00; B26F 3/12; B26D 3/006

(57) ABSTRACT

A working tool including a tool body with a distal end at which a first engagement structure is disposed and an interchangeable working member including a mounting base and a working portion connected to a distal end of the mounting base. The mounting base includes a second engagement structure disposed at a proximal end of the mounting base and configured to engage with the first engagement structure. The working member is configured to be electrically connected with the tool body upon attachment to the tool body. The working tool is configured to allow the working member to be detached from the tool body and allow another working member with the second engagement structure to be attached to the tool body.

### CROSS-REFERENCE TO RELATED APPLICATIONS

This application is a national phase filing under 35 U.S.C. § 371 of International Application No. PCT/CN2021/132385 filed Nov. 23, 2021, the entire content of which is incorporated by reference herein.

### FIELD

The present invention relates to the field of miniature industrial tools, and specifically to a working tool. The present invention further relates to a working member for the working tool and a working tool kit.

### BACKGROUND

Handheld working tools currently available in the market usually can only provide a single working function such as branding, cutting and trimming. In people's current life, there are usually application scenarios that require different working modes, so users have to purchase multiple different working tools, which will cause the users a certain economic burden and pressure in accommodating the working tools.

Therefore, it is desirable to provide a working tool, a working member of the working tool, and a working tool kit to at least partially solve the above-mentioned problem.

### SUMMARY

The present disclosure provides, in one aspect, a working tool including a tool body with a distal end at which a first engagement structure id disposed, and an interchangeable working member. The interchangeable working member includes a mounting base and a working portion connected to a distal end of the mounting base. The mounting base includes a second engagement structure disposed at a proximal end of the mounting base and is configured to engage with the first engagement structure. The working member is configured to be electrically connected with the tool body upon attachment to the tool body. The working tool is configured to allow the working member to be detached from the tool body and allow another working member with the second engagement structure to be attached to the tool body.

The present disclosure provides, in another aspect, an interchangeable working member for a working tool including a mounting base configured as a substantially rotationally symmetric structure about a central axis, a proximal end of the mounting base configured to engage with a front end of a tool body of the working tool and to be electrically connected with the tool body upon engagement with the tool body, and a working portion connected to a distal end of the mounting base. The working member is configured to enable a user to select a desired working member from at least two working members with different structure, and attach the selected working member to the tool body.

### BRIEF DESCRIPTION OF THE DRAWINGS

Reference may be made to preferred embodiments shown in the accompanying drawings to better understand the above and other objects, features, advantages and functions of the present invention. The same reference numbers in the figures refer to the same components. Those skilled in the art should understand that the figures are intended to schematically illustrate the preferred embodiments of the present invention, not to limit the scope of the present invention. The components in the figures are not drawn to scale.

FIG. 1 is a perspective view of a working tool.

FIG. 2A is a perspective view of a working member of the working tool in FIG. 1.

FIG. 2B is a perspective view of a portion of the working member of FIG. 2A.

FIG. 2C is a perspective view of another embodiment of a working member.

FIG. 3 is a perspective view of the working member of FIG. 2A.

FIG. 4 is a perspective view of the tool body of FIG. 1.

FIG. 5 is a partial section view of a housing of the main body of the working tool of FIG. 1.

FIG. 6A is a side view of embodiments of working members.

FIG. 6B is a side view of an embodiment of a working member.

FIG. 7 is a perspective view of another embodiment of a working member.

FIG. 8A is a perspective view of the working member of FIG. 7.

FIG. 8B is a perspective view of a portion of the working member of FIG. 8A.

FIG. 8C is a perspective view of a portion of the working member of FIG. 8A.

FIG. 9 is a perspective view of another embodiment of a working member.

FIG. 10 is a plan view of a guide of the working member of FIG. 9.

### DETAILED DESCRIPTION

Specific embodiments of the present invention will be described in detail hereunder with reference to the figures. What are described here are only preferred embodiments according to the present invention, and those skilled in the art can envisage other modes for implementing the present invention based on the preferred embodiments, and said other modes also fall within the scope of the present invention.

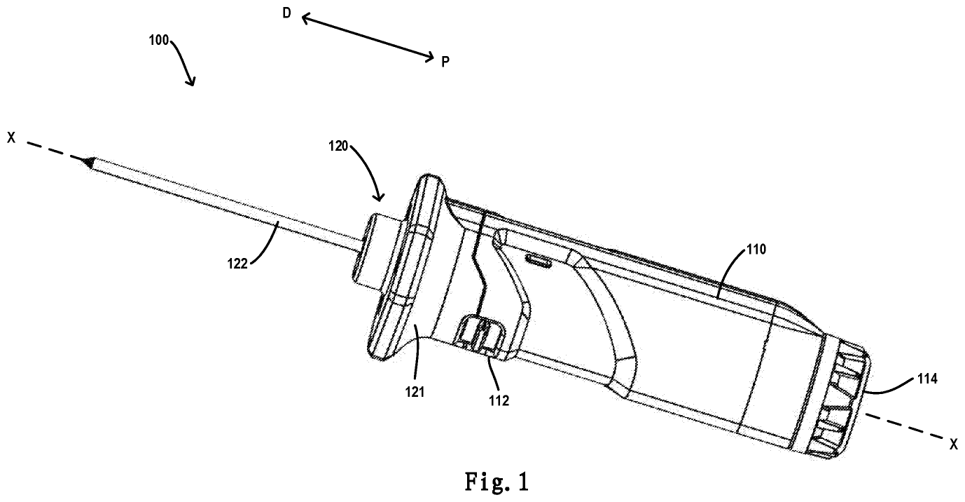

FIG. 1 through FIG. 10 show some preferred embodiments of a working tool, a working member and a working tool kit according to the present invention. The working tool according to the present invention is preferably a handheld electrically-heated working tool. The working tool for example may be used for cutting plastic foam, sponge or the like; drilling the plastic foam or sponge; branding or engraving on a wooden material. The working tool according to the present invention may include an interchangeable working member. Different working members are suitable for objects of different materials and different thickness, and are used to produce different predetermined working depths and so on.

Firstly, it needs to be appreciated that directional terms and positional terms in the present invention should be understood as relative directions and positions, other than absolute directions and positions. The directional terms and positional terms in the present invention may be illustrated with reference to exemplary structures shown in FIG. 1 through FIG. 10. For example, “central axis” mentioned in the present invention may be understood as an axis X-X shown in FIG. 1; “proximal direction” may be understood as a direction parallel to the central axis and adjacent to the user (as understood when the user grips the working tool to work); “distal direction” may be understood as a direction parallel to the central axis and away from the user (as understood when the user grips the working tool to work); “circumferential” and “radial” may be understood as a circumferential direction and a radial direction about the central axis X-X.

“First”, “second”, “third”, “fourth”, “fifth” and so on mentioned in the present invention may not have any association and order therebetween. Existence of “second” does not mean certain presence of “first”. For example, as will be described in detail hereunder, there might exist a working tool which only includes a fifth working member, and does not necessarily include a first working member, a second working member, a third working member and a fourth working member.

Reference is made first to FIG. 1 through FIG. 5. One embodiment of the present invention provides an exemplary working tool 100. The working tool 100 includes a tool body 110 and an interchangeable working member 120. Working members involved in FIG. 1 through FIG. 5 are referred to as a first working member to distinguish themselves from other working members mentioned later. The first working member 120 further includes a mounting base 121 and a working portion 122 connected to a distal end of the mounting base 121. A first engagement structure 113 is disposed at a distal end of a tool body 110, a second engagement structure 1212 is disposed at a proximal end of the mounting base 121, the first working member 120 can be attached to a front end of the tool body 10 via engaging the second engagement structure 1212 with the first engagement structure 113, and to be electrically connected with the tool body 110 upon attachment.

The working tool 100 allows the user to remove the first working member 120 from the tool body 110 and select and mount another working member on the tool body 110; the working tool 100 also allows the user to re-mount the first working member 120 to the tool body 110 when he needs to use the first working member 120 again. Specifically, the working tool 100 is configured to allow the user to select the working member based on at least one of a target working depth, a size of a target object, a material of the target object and a working type.

In the present embodiment, the mounting base 121 of the first working member 120 and the tool body 110 are each formed as a substantially rotationally symmetric structure about a central axis. The first working member 120 and the tool body 110 each have some preferred settings, and they both further have some preferred settings that engage with each other.

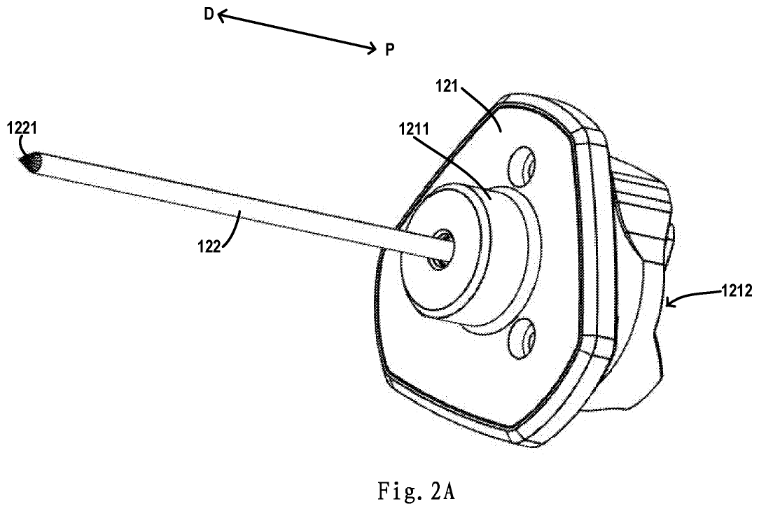

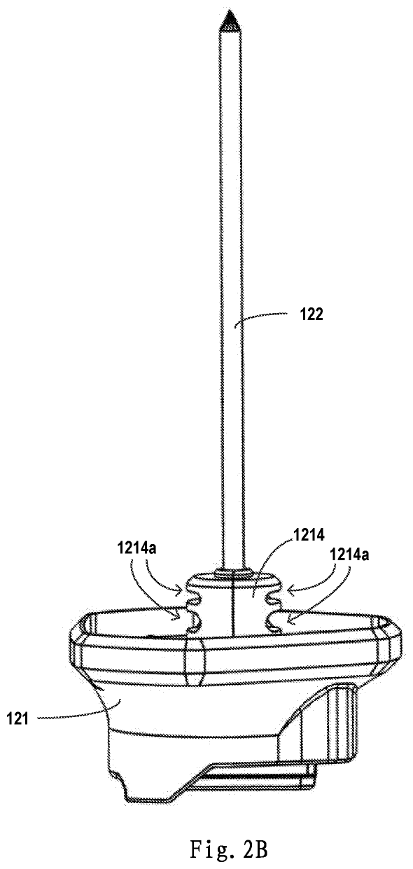

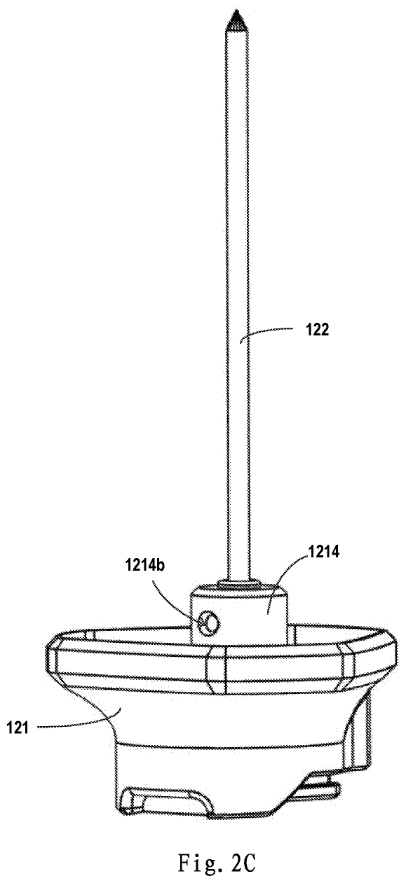

For example, referring to FIG. 1 and FIG. 2A, the working portion 122 is a linear working tip extending along the central axis. The linear working tip is preferably an electrically-heated type thin metal tube, and an electric heating wire is wound around or received in an end 1221 of the linear working top. The tip 1221 of the working member 122 is a needle-point structure that tapers radially toward a distal side, so that the working tool 100 can be used for grooving or cutting foam.

FIG. 2B is a view of the first working member 120 of FIG. 2A after a distal end cap 1211 of the mounting base 121 thereof is removed. FIG. 2B shows a holding portion 1214 for holding the working portion 122 in the interior of the mounting base 121. The holding portion 1214 is a small cylindrical structure formed about the central axis and is provided with several grooves 1214a extending transversely to the central axis to reduce the amount of material used and to prevent sinkage of holding portion. FIG. 2C shows an alternative form of the structure of FIG. 2B, wherein the grooves on the holding portion 1214 is replaced by a through hole 1214b transverse to the central axis in FIG. 2C. The through hole 1214b can be a screw hole and used to provide additional retention for the working portion 122. It can be known that what are shown in FIG. 2B and FIG. 2C are both the first working members 120 which are consistent with each other in both function and external structure, and are only slightly different in the holding portion 1214 for holding the working portion 122.

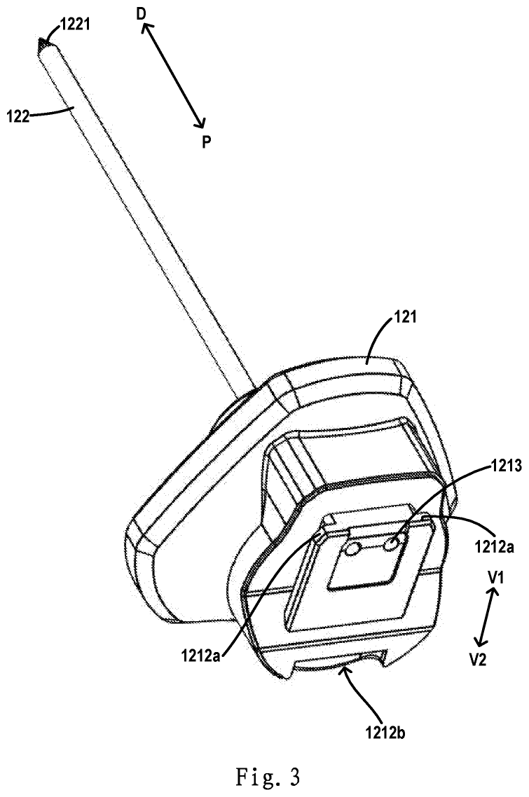

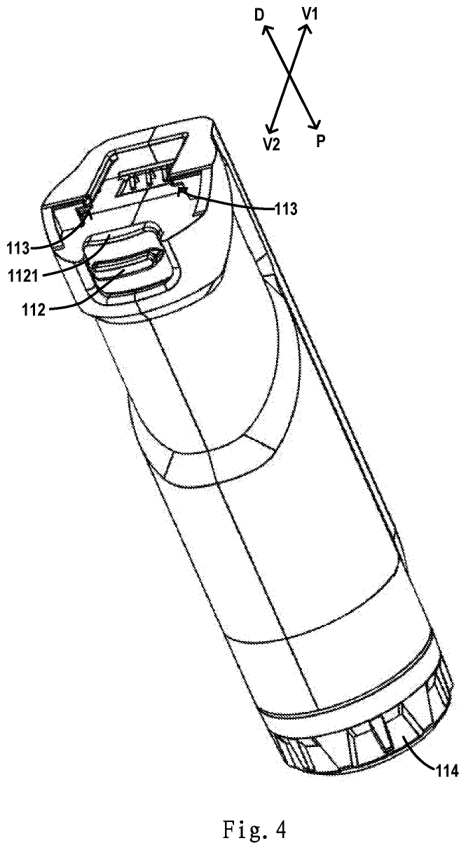

Further referring to FIG. 3 and FIG. 4, the first engagement structure 113 is an engagement groove on a front end face of the tool body 110, and the second engagement structure 1212 is a pair of engagement protrusions 1212a provided on a proximal end face of the first working member 120. The pair of engagement protrusions 1212a extend and protrude along a plane perpendicular to the central axis. One end (i.e., the most upstream end in a V2 direction) of the engagement groove is open and the other end (i.e., the most upstream end in a V1 direction) is closed. The first working member 120 is mounted to the tool body 110 in the direction V1 perpendicular to the central axis by sliding the engagement protrusions 1212a into the engagement groove from an opening, and can be disengaged from the tool body 110 by sliding the engagement protrusions 1212a in the direction V2 opposite to the direction V1.

Meanwhile, the tool body 110 further includes a mounting button 112 disposed at or near the opening of the engagement groove. The mounting button 112 is configured to be actuated between a locked position for preventing the working member from being mounted to the tool body 110 and being disengaged from the tool body 110, and an unlocked position for allowing the working member to be mounted to the tool body 110 and disengaged from the tool body 110. In the present embodiment, the mounting button 112 slides in a proximal direction P to be actuated from the locked position to the unlocked position, and slides in a distal direction D to be actuated from the unlocked position to the locked position. When the mounting button 112 is at the locked position, the front end 1121 of the mounting button 112 (see FIG. 4) stops in a distally-recessed notch 1212b (see FIG. 3) of the proximal end face of the mounting base 121, thereby closing the engagement protrusions 1212a in the engagement groove.

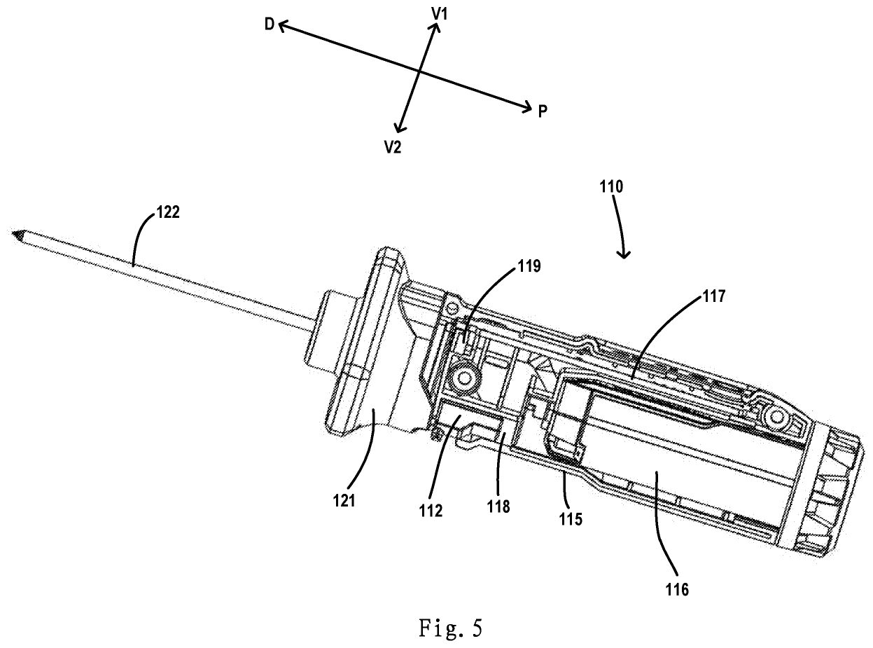

Furthermore, referring to the schematic view of the internal structure of the tool body 110 shown in FIG. 5, a spring located at the proximal end of the mounting button 112 may also be provided in the internal space of the tool body 110. The figure shows a spring space 118 for receiving the spring, but does not show the spring. The spring is a spring parallel to the central axis. The spring is compressed when the mounting button 112 is at the unlocked position; and the spring restores to its original length when the mounting button 112 is at the locked position; alternatively, the spring is also slightly compressed when at the locked position, and the spring is further compressed when at the unlocked position.

Although in the present embodiment, the mounting button 112 is slid between the locked position and the unlocked position, the mounting button 112 may pivot or make other motions between the locked position and the unlocked position in other embodiments that are not shown.

Turning back to FIG. 3, the proximal end face of the first working member 120 is further provided with an electrical contact 1213 for making electrical contact with an electrical contact portion 119 of the tool body 110. The electrical contact portion 119 is shown in the internal structure of the tool body 110 shown in FIG. 5. Preferably, a identification element is integrated on the electrical contact portion 119. The identification element is configured to be communicatively connected with a control element in the tool body 110 to send a signal to the control element so that the control element processes and recognizes the type of the first working member 120 attached to the tool body 110. Such a setting allows the tool main body 110 to intelligently recognize the attached working member and provide a corresponding rated power and/or electric heating temperature to improve the convenience of operation. The tool body 110 can provide the working member 122 with an electric heating temperature of approximately 450° C., and the electric heating temperature may be properly and intelligently adjusted according to the working portions of different working members.

Further referring to FIG. 5, a PCB 117 serving as the control element is provided in the tool body 110, and the electrical contact portion 119 is directly provided on the control element. Preferably, the electrical contact portion 119 may be elastically connected with the control element. When the electrical contact portion 119 and the electrical contact 1213 on the working member are properly engaged, the electrical contact portion 119 bears a certain biasing force for biasing the electrical contact portion 119 further distally so that the electrical contact portion 119 and the electrical contact 1213 are pressed together tightly. Such an arrangement ensures sufficient contact between the electrical contact portion 119 and the electrical contact 1213, and can ensure the effectiveness of electrical conduction.

FIG. 5 further shows some examples of the preferred layout of the interior of the tool body 110. For example, a battery 116 is mounted in the tool body 110, and the battery 116 is a removable dry battery (e.g. a 4V battery) or a rechargeable battery. The proximal end of the tool body 110 may be provided with an openable battery end cap 114 (see FIG. 1) for removing and mounting the battery 116. The battery 116 also defines a battery axis parallel to the central axis, but it can be clearly seen from FIG. 5 that the battery axis is non-colinear with the central axis so that a radial spacing between a top face (namely, an end face in the V1 direction) of the battery 116 and the housing 115 is greater than the radial spacing between a bottom face (namely, an end face in the V2 direction) of the battery 116 and the housing 115. Preferably, the PCB 117 extends from a location with a maximum radial spacing among the radial spacings to the electrical contact portion 119 in a direction parallel to the central axis. Such an arrangement allows the PCB 117 and the battery 116 to partially overlap in the extension direction of the central axis, thereby reducing the overall length of the tool body 110 and making the tool body 110 compact and light.

In addition, the housing 115 of the tool body 110 is further provided with a power button, operation start button and a mode switching indicator light. Preferably, the power button, the operation start button are respectively disposed on opposite sides with respect to the central axis relative to the mounting button 112. Such an arrangement makes the power button, operation start button far apart from the mounting button 112 so that the user is not prone to mis-operate.

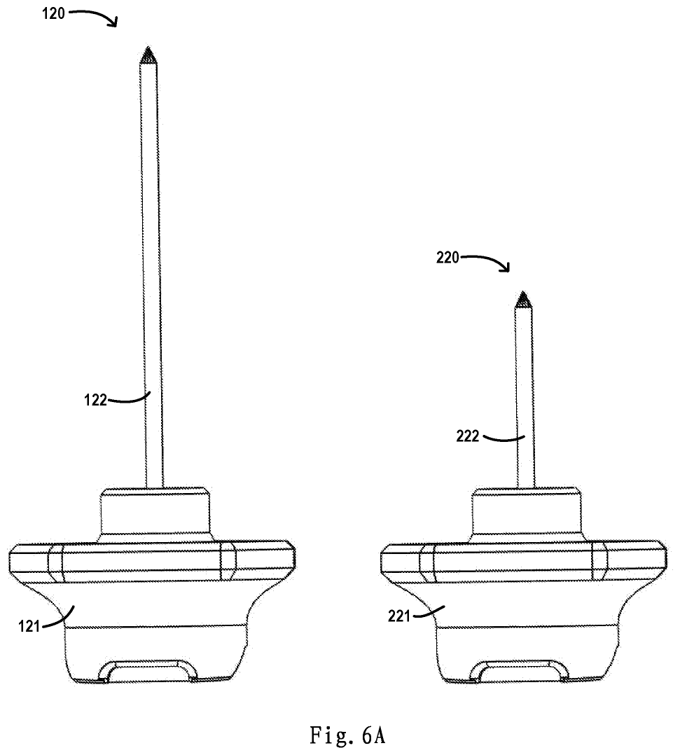

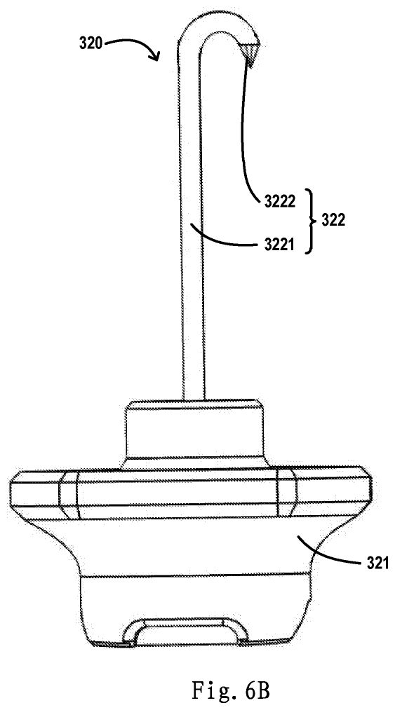

The present invention further provides some examples of other working members with structures similar to the first working member 120, wherein two examples are shown in FIG. 6A and FIG. 6B.

FIG. 6A shows a comparison between another working member and the first working member 120 shown in FIG. 1. For the convenience of description, the newly shown working member in FIG. 6A is referred to as a second working member 220. The second working member 220 includes a base 221 which is the same as the base 121 of the first working member 120 and a linear working portion 222 similar to the working portion 122. The difference between the second working member 220 and the first working member 120 lies in that the length of the working portion 222 of the second working member 220 is shorter than the length of the working portion 122 of the first working member 120, so that the second working member 220 may be applied to a scenario different from the first working member 120. For example, if the user needs to achieve more precise engraving or cutting with a smaller target depth, then the second working member 220 may be selected and attached to the tool body.

FIG. 6B shows yet another working member, which is referred to as a third working member 320 for the convenience of description. The third working member 320 includes a mounting base 321 which is the same as the mounting base 121 shown in FIG. 1 and a working portion 322 provided on the mounting base 321. The working portion 322 of the third working member 320 includes a linear portion 3221 extending along the central axis and an elbow tip 3222 bent back from the distal end of the linear portion 3221 toward the proximal direction. The third working member 320 for example can be used to reach inside to create a groove inside the target material.

The second working member 220 and the third working member 320 may also be thin metal tubes, with an electrical heating wire being wound around or received in the respective distal ends.

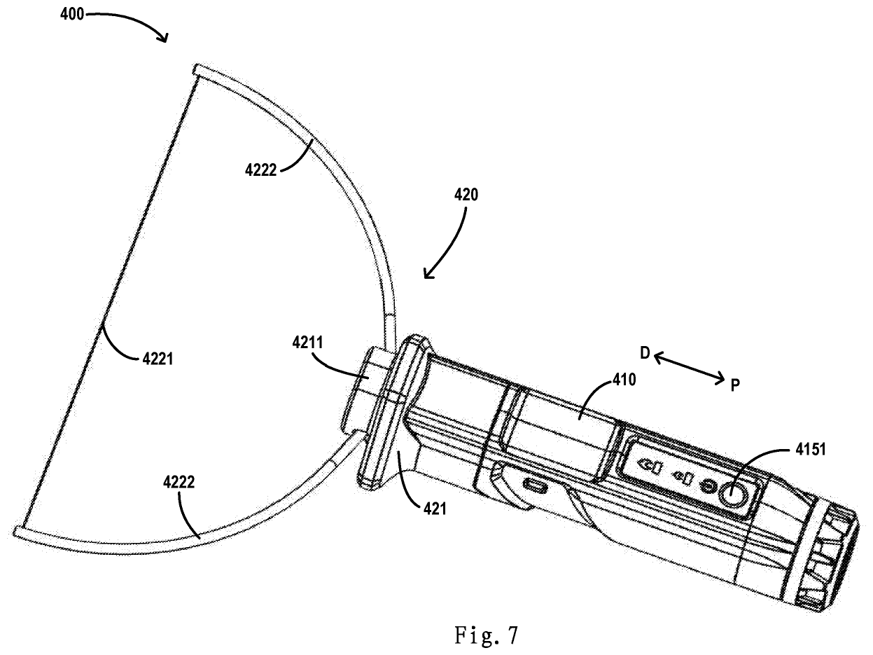

FIG. 7 shows a working tool 400 according to another preferred embodiment of the present invention. The working tool 400 includes a tool body 410 and a working portion 420, wherein the tool body 410 and the tool body 410 shown in FIG. 1 are the same part. That is to say, the working member 420 of the working tool 400 shown in FIG. 1 is detached from the tool body 410, and the working member 420 shown in FIG. 7 is attached to the tool body 410 to obtain the working tool 400 shown in FIG. 7. For the convenience of description, the working member 420 shown in FIG. 7 is referred to as a fourth working member 420.

The tool body 410 of the working tool 400, from the perspective shown in FIG. 7, enables its power button 4151 to be observed. The power button 4151 is further provided with several temperature adjustment indicator lamps. For example, a low-temperature operation mode is activated after the power button 4151 is triggered once, a high-temperature operation mode may be activated after the power button 4151 is triggered a second time, and the tool is turned off after the power button 4151 is triggered a third time.

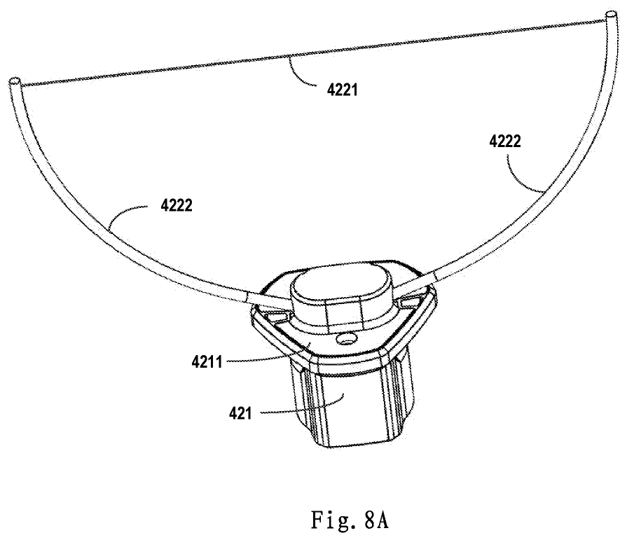

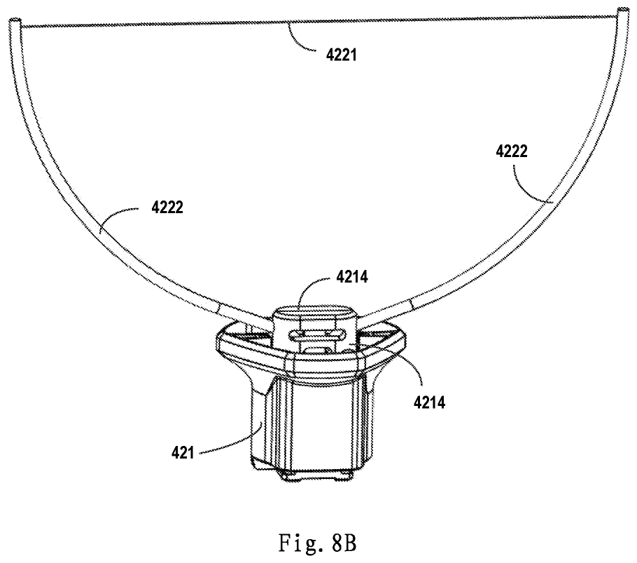

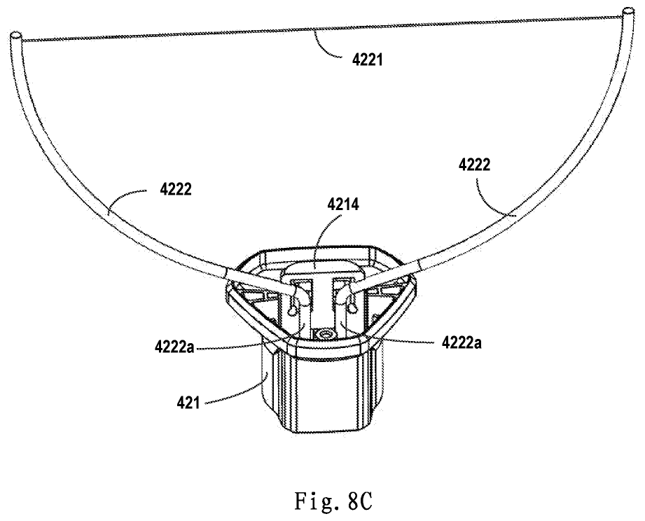

Referring to FIG. 7 and FIG. 8A, the fourth working member 420 of the working tool 400 includes a mounting base 421 and a working portion. The mounting base 421 has substantially the same structure as the mounting base 421 shown in FIG. 1. The working portion includes two support legs 4222 extending distally from the mounting base 421 and spaced apart from each other, and a heating wire 4221 supported by the support legs 4222. The heating wire 4221 extends from the mounting base 421 and extends along the two support legs 4222 respectively, and is suspended and tensioned between the distal ends of the two support legs 4222. The suspended portion of the heating wire 4221 is used to directly contact the target object, and the suspended portion is substantially perpendicular to the central axis. It may be appreciated that the heating wire 4221 may be a metal wire with a small diameter, while the diameter of the support legs 4222 is relatively large, so the portion of the heating wire 4221 overlapping the support legs 4222 cannot be clearly shown in the figures.

Preferably, the two support legs 4222 are jointly formed into an bow shape, and the suspended and tensioned portion of the heating wire 4221 is similar to a string of a bow. The heating wire 4221 may be used for operations such as cutting foam. Furthermore, since the length of the portion of the heating wire 4221 in direct contact with the target object is large, the fourth working member 420 can be used to quickly cut a larger-sized target object. The fourth working member 420 is particularly suitable for cutting thick plastic foam.

FIG. 8B and FIG. 8C show the internal structure of the mounting base 421 of the fourth working member 420. FIG. 8B is a schematic view of the internal structure after the distal end cap 4211 of the mounting base 421 in FIG. 8A is removed. A structure for clamping the support legs 4214 in the interior includes two clamping blocks 4214 that are symmetrically arranged about the longitudinal axis and clamped to each other. FIG. 8C shows a schematic structural view after one clamping block 4214 is removed. It may be seen that the proximal ends 4222a of the two support legs 4222 are clamped in corresponding clamping grooves of the clamping blocks 4214.

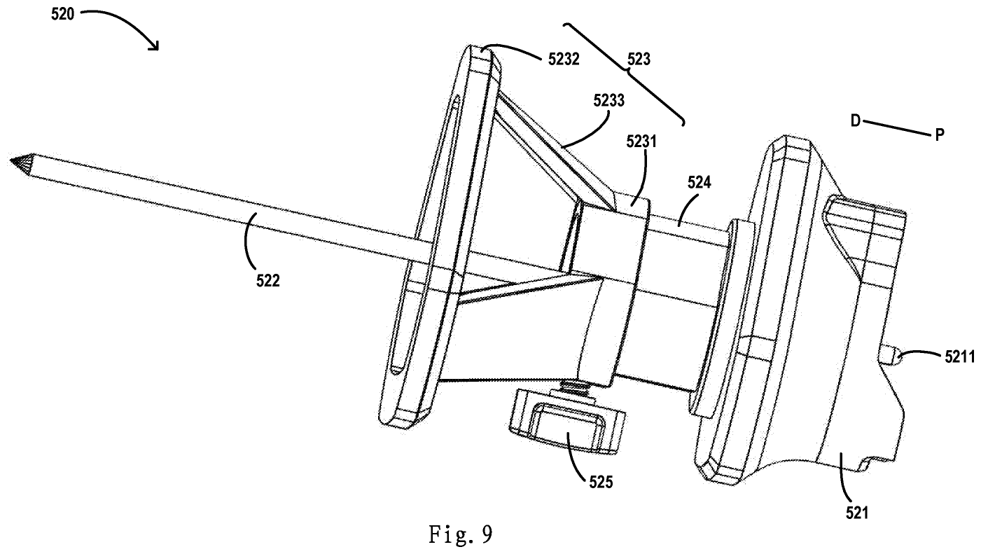

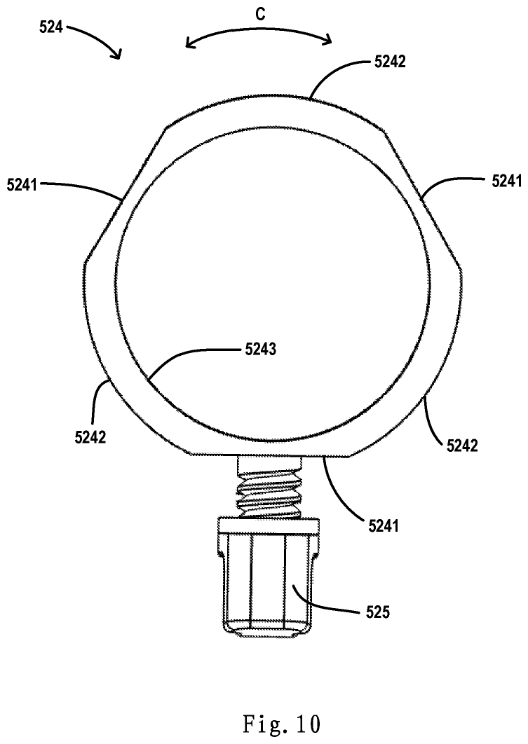

In addition to the first working member 120, the second working member 220, the third working member 320 and the fourth working member 420, the present invention further provides another preferred example of the working member, which is shown in FIG. 9 and FIG. 10.

For the convenience of description, the working member shown in FIG. 9 and FIG. 10 is referred to as a fifth working member 520. The base of the fifth working member 520 is similar to the bases of the previous four working members, and an electrical contact 5211 at the proximal end thereof can be clearly seen in FIG. 9. A working portion 522 of the fifth working member 520 is a working tip extending along the central axis. The linear working tip is preferably an electrically-heated type thin metal tube, with an electrical heating wire being wound around or received in a distal end thereof. The fifth working member 520 further includes a depth adjusting mechanism connected to the distal end of the mounting base 521 and at least partially surrounding the working tip. The distal end of the working portion protrudes relative to a distal end face of the depth adjusting mechanism to define a target working depth in the direction of the central axis between the distal end of the working portion and the distal end face of the depth adjusting mechanism. In addition, the depth adjusting mechanism can be operated to make the position of its distal end face adjustable along the central axis to adjust the target working depth.

Further referring to FIG. 9, the depth adjusting mechanism includes a guide 524 fixed on the mounting base 521 and a movable member 523 slidable relative to the guide 524. The depth adjusting mechanism further includes a locking knob 525 configured to allow the user to operate and adjust the movable member 523 when the locking knob is loosened, and to lock the movable member 523 when the locking knob is tightened. The movable member 523 is an integral member and includes a slidable portion 5231, a depth limiting portion 5232, and a connection portion 5233 connecting the slidable portion 5231 with the depth limiting portion 5232. The slidable portion 5231 is configured as an annular structure that fits around the guide 524 and is slidable along the guide 524. The depth limiting portion 5232 is located on a distal side of the annular portion and formed as an annular structure surrounding the working tip. A distal end face of the movable member 523 is defined on the depth limiting portion 5232.

Preferably, an average radial distance between the depth limiting portion 5232 and the working tip is greater than an average radial distance between the slidable portion 5231 and the working tip, the connection portion 5233 thus extends in a direction parallel to the central axis as well as the radial direction, and the slidable member is formed on the whole as a stretched umbrella-like structure. Such an arrangement enables a large surface area of the target object in contact with the depth limiting surface, and can improve the stability upon operation.

Also preferably, referring to the schematic view of the distal end face of the guide 524 given in FIG. 10, a side wall of the guide 524 around the central axis includes at least two planar walls 5241 and at least two arcuate walls 5242, wherein the planar walls 5241 and the arcuate walls 5242 are alternately arranged in a circumferential direction C. The arrangement of the planar walls 5242 may prevent the movable member 523 from rotating about the guide 524, and the arrangement of the arcuate walls 5242 may reduce the sliding resistance of the movable member 523 on the guide 524. An inner circumference 5243 of the guide 524 defines a complete circular shape or an approximately circular shape.

The fifth working member 520 can provide different target working depths, and the target working depths can be used to define any depth value between a maximum depth and a minimum depth. Such an arrangement can provide the user with multiple operation possibilities, so that the fifth working member 520 can be applicable for multiple operating environments. For example, the fifth working member 520 can be applicable for a working scene with a large target working depth.

The present invention further provides a working member for a working tool. The working member can be detachably attached to the tool body of the working tool. The working member can be produced and sold independently of the tool body. The first working member, the second working member, the third working member, the fourth working member and the fifth working member shown in FIG. 1 through FIG. 10 and relevant descriptions should be regarded as specific embodiments of the working member according to the present invention.

The present invention further provides a working tool kit, which includes a tool body and at least two interchangeable working members. The tool body may be the tool body shown in FIG. 1 or FIG. 7. The at least two interchangeable working members may include one or more of the first working member, the second working member, the third working member, the fourth working member and the fifth working member shown in FIG. 1 through FIG. 10. The user can select a desired working member from all the interchangeable working members based on at least one of the target working depth, the size of the target material, the material of the target material and the working type.

As mentioned above, a recognition element is integrated on the electrical contact portion of the tool body of the working tool kit. The recognition element is configured to be communicatively connected with a control element in the tool body to send a signal to the control element so that the control element processes and recognizes the type of the working member attached to the tool body. The tool body of the working tool kit can automatically recognize the type of the attached working member and provide a corresponding power supply.

The depictions of the tool body and the first working member, the second working member, the third working member, the fourth working member and the fifth working member shown in FIG. 1 through FIG. 10 should be considered as preferred embodiments of the working tool kit. For example, in one embodiment, the working tool kit may include the tool body, the first working member, the second working member and the third working member, so the above depictions of the tool body, the first working member, the second working member and the third working member should be considered as preferred embodiments of the working tool kit.

It can be known with reference to the foregoing depictions of some preferred embodiments of the present invention that the present invention can allow the user to engage the same tool body with working members that can provide different functions, to achieve different working purposes. In the technical solution provided by the present invention, the locking and unlocking modes of the working member and the tool body are simple and firm, and meanwhile, a possibility of allowing the tool body to intelligently recognize the working member is also provided.

In another aspect, the present invention further provides specific settings and options of multiple optimized working members, provides specific examples in which the working tool is assembled to serve as a cutting tool, a drilling tool, a branding tool etc., and further provides a solution for adjusting the target working depth.

In a further aspect, the structural layout in the tool body of the present invention is reasonable, and partially placing the PCB between the battery and the housing can reduce the overall size of the tool body; directly disposing the electrical contact portion electrically connected with the working member on the PCB can allow the tool body to engage a working member with a larger rated power.

The foregoing description of various embodiments of the present invention has been provided to those having ordinary skill in the art for purposes of illustration. This does not mean that the present invention excludes other embodiments or is limited to a single disclosed embodiment. As stated above, those having ordinary skill in the art as taught above will understand many alternatives and modifications of the present invention. Thus, although some alternative implementations have been described in detail, those having ordinary skill in the art will understand or relatively easily develop other implementations. The present invention is intended to include all alternatives, modifications and variations of the present invention described herein, as well as other embodiments which fall within the spirit and scope of The present invention described above.

1. A working tool comprising:
a tool body with a distal end at which a first engagement structure is disposed; and
an interchangeable working member including a mounting base and a working portion connected to a distal end of the mounting base, the mounting base including a second engagement structure disposed at a proximal end of the mounting base and configured to engage with the first engagement structure, the working member configured to be electrically connected with the tool body upon attachment,
wherein the working tool is configured to allow the working member to be detached from the tool body, and allow another working member with the second engagement structure to be attached to the tool body.

2. The working tool according to claim 1, wherein the working tool defines a central axis extending from a proximal end to the distal end of the tool body, and the mounting base is formed as a substantially rotationally symmetric structure about the central axis.

3. The working tool according to claim 2, wherein the working member includes a working portion, the working portion including one of a linear working tip extending along the central axis, or
a linear portion extending along the central axis and an elbow tip bent from a distal end of the linear portion toward a proximal direction.

4. The working tool according to claim 2, wherein the working member includes a working portion having a working tip extending along the central axis, the working member further includes a depth adjusting mechanism connected to the distal end of the mounting base and at least partially surrounding the working tip,
wherein a distal end of the working portion protrudes relative to a distal end face of the depth adjusting mechanism to define a target working depth along the central axis between the distal end of the working portion and the distal end face of the depth adjusting mechanism, and
the depth adjusting mechanism can be operated to make a position of its distal end face adjustable along the central axis.

5. The working tool according to claim 4, wherein the depth adjustment mechanism comprises:
a guide fixed on the mounting base;
a movable member comprising:
a slidable portion configured as an annular structure that fits around and is slidable along the guide;
a depth limiting portion located on a distal side of the annular portion and formed as an annular structure surrounding the working tip, the distal end face being defined on the depth limiting portion; and
a connection portion connecting the slidable portion with the depth limiting portion.

6. The working tool according to claim 5, wherein an average radial distance between the depth limiting portion and the working tip is greater than an average radial distance between the slidable portion and the working tip.

7. The working tool according to claim 5, wherein a side wall of the guide around the central axis comprises at least two planar walls and at least two arcuate walls, the planar walls and the arcuate walls being alternately arranged in a circumferential direction.

8. The working tool according to claim 3, wherein the working portion comprises a thin metal tube, and an electrical heating wire is wound around or received in a distal end of the thin metal tube.

9. The working tool according to claim 2, wherein the working portion comprises:
two support legs extending distally from the mounting base and spaced apart from each other;
an electrical heating wire which extends from the mounting base and extends along the two support legs respectively, and is suspended and tensioned between distal ends of the two support legs.

10. The working tool according to claim 9, wherein the two support legs are jointly formed as a bow-shaped structure.

11. The working tool according to claim 2, wherein a distal end face of the tool body is provided with an electrical contact portion in direct electrical contact with the working member, an identification element is integrated on the electrical contact portion, the identification element is configured to be communicatively connected with a control element in the tool body to send a signal to the control element so that the control element processes and identifies a type of the working member attached to the tool body.

12. The working tool according to claim 11, wherein the electrical contact portion is directly disposed on the control element.

13. The working tool according to claim 12, wherein the working portion comprises an electrically-heatable material, a battery is disposed in the tool body, the battery defines a battery axis that is parallel to the central axis and is spaced apart from the central axis, the battery having a top end radially spaced from the tool body by a first distance defining a first spacing and a bottom end radially spaced from the tool body by a second distance defining a second spacing that is less than the first spacing, and
wherein the control element is a PCB extending from a location with the first spacing to the electrical contact portion in a direction parallel to the central axis.

14. The working tool according to claim 2, wherein the first engagement structure comprises an engagement groove disposed on a distal end face of the tool body and having an end open and and an opposite closed end, the second engagement structure comprises an engagement protrusion disposed on a proximal end face of the mounting base and corresponding to the engagement groove, and the the working member is mounted to the tool body in a direction perpendicular to the central axis by sliding the engagement protrusion into the engagement groove,
the tool body further comprising a mounting button disposed at or near the open end of the engagement groove, the mounting button is configured to be actuated between a locked position for preventing the working member from being mounted to and disengaged from the tool body, and an unlocked position for allowing the working member to be mounted to and disengaged from the tool body.

15. The working tool according to claim 14, wherein the mounting button is configured to slide between the locked position and the unlocked position in a direction parallel to the central axis, the tool body further including a spring positioned on a proximal side of the mounting button and being parallel to the central axis, wherein the spring is compressed at least when the mounting button is located at the unlocked position.

16. The working tool according to claim 14, wherein an operation start button is disposed on the tool body, and the operation start button and the mounting button are disposed opposite about the central axis.

17. The working tool according to claim 1, wherein the working tool is configured to allow a user to select the working member based on at least one of a target working depth, a size of a target material, a material of the target material and a working type.

18. An interchangeable working member for a working tool comprising:
a mounting base configured as a substantially rotationally symmetric structure about a central axis, a proximal end of the mounting base being configured to engage with a front end of a tool body of the working tool, and to be electrically connected with the tool body upon engagement with the tool body; and
a working portion connected to a distal end of the mounting base,
wherein the working member is configured to enable a user to select a desired working member from at least two working members with different structures, and attach the selected working member to the tool body.

19. The working member according to claim 18, wherein the working portion includes one of:
a linear working tip extending along the central axis,
a linear portion extending along the central axis and an elbow tip bent from a distal end of the linear portion toward a proximal direction,
a working tip extending along the central axis and a depth adjusting mechanism connected to the mounting base and at least partially surrounding the working tip; or
a support having a support proximal end connected to the mounting base and two support legs extending distally from the support proximal end and spaced apart from each other and an electrical heating wire extending from the mounting base along the two support legs and suspended and tensioned between a distal end of each of the two support legs.

20. The working member according to claim 18, wherein the working portion includes a linear working tip extending along the central axis, and a depth adjusting mechanism connected to the mounting base and at least partially surrounding the working tip,
wherein a distal end of the working portion protrudes relative to a distal end face of the depth adjusting mechanism to define a target working depth along the central axis between the distal end of the working portion and the distal end face of the depth adjusting mechanism, and
the depth adjusting mechanism is configured to make a position of distal end face adjustable along the central axis.

21. The working member according to claim 20, wherein the depth adjustment mechanism comprises:
a guide fixed on the mounting base;
a movable member having:
a slidable portion configured as a first annular structure that fits around and is slidable along the guide;
a depth limiting portion located on a distal side of the first annular structure and formed as a second annular structure surrounding the working tip, the distal end face defined on the depth limiting portion; and
a connection portion connecting the slidable portion with the depth limiting portion.

22. The working member according to claim 21, wherein an average radial distance between the depth limiting portion and the working tip is greater than an average radial distance between the slidable portion and the working tip.

23. The working member according to claim 21, wherein a side wall of the guide around the central axis comprises at least two planar walls and at least two arcuate walls, the planar walls and the arcuate walls being alternately arranged in a circumferential direction.

24. The working member according to claim 18, wherein the working portion of the working member including:
a support having a support proximal end connected with the mounting base and two support legs extending distally from the support proximal end and spaced apart from each other;
an electrical heating wire extending from the mounting base along the two support legs and suspended and tensioned between a distal end of each of the two support legs,
wherein the two support legs are jointly formed as a bow-shaped structure.

25-41. (canceled)
